(19) United States
(12) Patent Application Publication
(10) Pub. No.: US 2010/0316378 A1
(43) Pub. Date: Dec. 16, 2010

(54) Laser Source Based On Fabry-Perot Laser Diodes And Seeding Method Using The Same

(76) Inventors: CHIEN-HUNG YEH, Hsinchu (TW); SIEN CHI, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/197,223

(22) Filed: Aug. 22, 2008

(30) Foreign Application Priority Data
Jul. 8, 2008 (TW) 097125759

(51) Int. Cl. H04J 14/02; H01S 3/13

(52) U.S. Cl. 398/58; 372/32

(57) ABSTRACT

Disclosed is directed to a laser source based on Fabry-Perot laser diodes (FP-LDs) and seeding method using the same. The laser source comprises a plurality of FP-LDs, an optical filter, and at least a fiber mirror. The FP-LDs are aligned to their corresponding filter modes of the optical filter, and output their optical spectrums. The optical spectrums are filtered via the optical filter then reflected into the FP-LDs. Each of the FP-LDs further outputs its optical spectrum with a form of continuous wave (CW) of single longitudinal mode (SLM). The outputted CWs may be treated as injected laser light sources. They may also be applied to the transmission architecture in wavelength-division-multiplexed passive optical networks.

### FIELD OF THE INVENTION

The present invention generally relates to a laser source based on Fabry-Perot laser diode (FP-LD) and seeding method using the same.

### BACKGROUND OF THE INVENTION

In recent years, as the fiber to the home (FTTH) technology may provide data transmission with broadband and high quality of service to the clients, the wavelength-division-multiplexed passive optical networks (WDM-PON) have attracted much attention. In actual WDM-PON system execution, the key question lies in how to realize the inexpensive optical transceiver at the optical line terminal (OLT) and the optical network unit (ONU).

Among the various transmission architectures of WDM-PON, a popular exemplary architecture is shown in FIG. 1, a transmission architecture using spectrum sliced broadband injection locked FP-LD. In this transmission architecture, the downstream light source may be E/L-broadband light source 110, and the upstream light source is C-broadband light source 120. OLT 140 and ONU 150 both use the bi-directional transceiver integrated from FP-LD and photo diode (PD). The front-end surface of the FP-LD is of low reflectivity, around 0.001, and requires only small amount of optical power injection. This type of transmission architecture may use the WDM wavelength of colorless light source and the inexpensive individual FP-LD to generate modulating signals.

The WDM-PON technology based on reflective semiconductor optical amplifier (RSOA) is also studied and tested for the network performance under actual data transmission. An exemplary architecture is shown in FIG. 2A, where the laser-injected schema is used to inject a continuous wave (CW) wavelength into each ONU. The network architecture proposes to use an independent CW WDM seed light.

Another exemplary architecture of WDM-PON technology based on RSOA is shown in FIG. 2B, where a schema with re-modulation signal data is used to suppress the downstream injection light data as the previous schema, while repeatedly using the downstream re-modulation optical signal as the seed light source. After the modulated optical signal is injected into the RSOA of each ONU, the optical signal will be reflected, amplified and modulated the upstream signal.

Both of the above two WDM-PON technologies based on RSOA use distributed feedback LD (DFB-LD) as the downstream transmission data wavelength and the laser light source of seed light to RSOA. Compared to FP-LD, the laser light source based on DFB-LD is expensive and also reduces the data transmission rate. The data transmission rate is about 1.25G bits or a few tens of mega bits per second.

### SUMMARY OF THE INVENTION

The exemplary embodiments according to the present invention may provide a laser source based on Fabry-Perot laser diodes (FP-LD) and the seeding method using the same.

In an exemplary embodiment, the disclosed is directed to a laser source based on FP-LD for the seeding light source of the WDM laser architecture. The laser source comprises a plurality of FP-LDs, an optical filter, and at least a fiber mirror (FM). Each FP-LD outputs a spectrum that is distributed within a range of a specific band. The optical filter filters the output spectrum of each FP-LD to identify each spectrum. The fiber mirror reflects each identified spectrum into the plurality of FP-LDs. Then, each FP-LD outputs a continuous wave (CW) as a seeding laser source.

In another exemplary embodiment, the disclosed is directed to a laser source based on FP-LD, applicable to an OLT of a transmission system. The OLT has an upstream laser source and a downstream laser source. The laser source comprises a plurality of FP-LDs with each FP-LD outputting a spectrum, an optical filter for identifying each output spectrum, and at least a fiber mirror for reflecting the identified spectrum into the plurality of FP-LDs. Then, each FP-LD uses a CW of single longitudinal mode (SLM) to output a corresponding spectrum. The OLT uses different band ranges and uses the laser source as its upstream and downstream laser sources.

Yet in another exemplary embodiment, the disclosed is directed to a seeding method using a laser source based on FP-LDs. The seeding method comprises: preparing and aligning a plurality of FP-LDs to the corresponding filter mode of an optical filter and outputting own corresponding spectrum; the optical filter filtering each spectrum of each of the plurality of FP-LDs; the filtered spectrum being reflected into the plurality of FP-LDs; and each FP-LD using a CW of SLM to output own corresponding spectrum as laser source for seeding.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of an exemplary transmission architecture based on spectrum sliced broadband injection locked FP-LD.

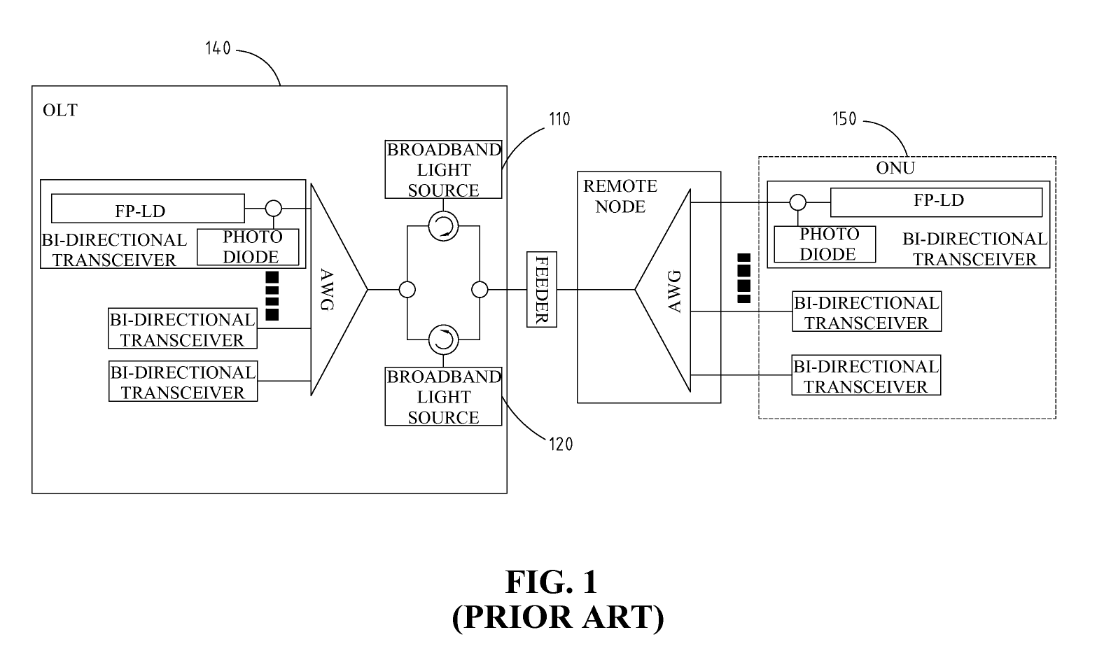

FIG. 2A shows a schematic view of an exemplary WDM-PON architecture based on RSOA.

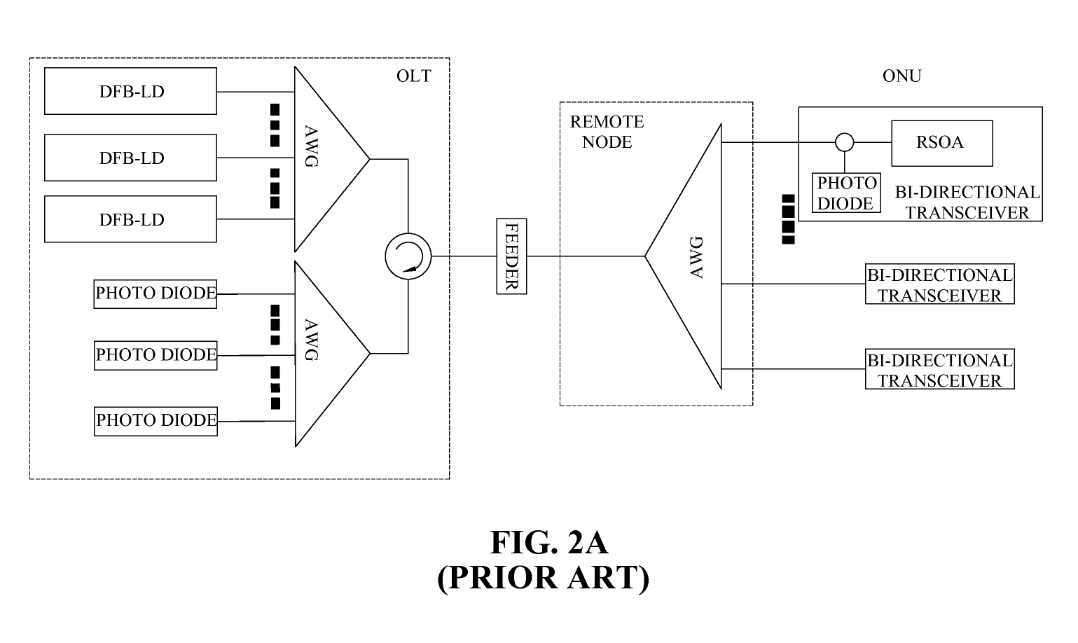

FIG. 2B shows a schematic view of another exemplary WDM-PON architecture based on RSOA.

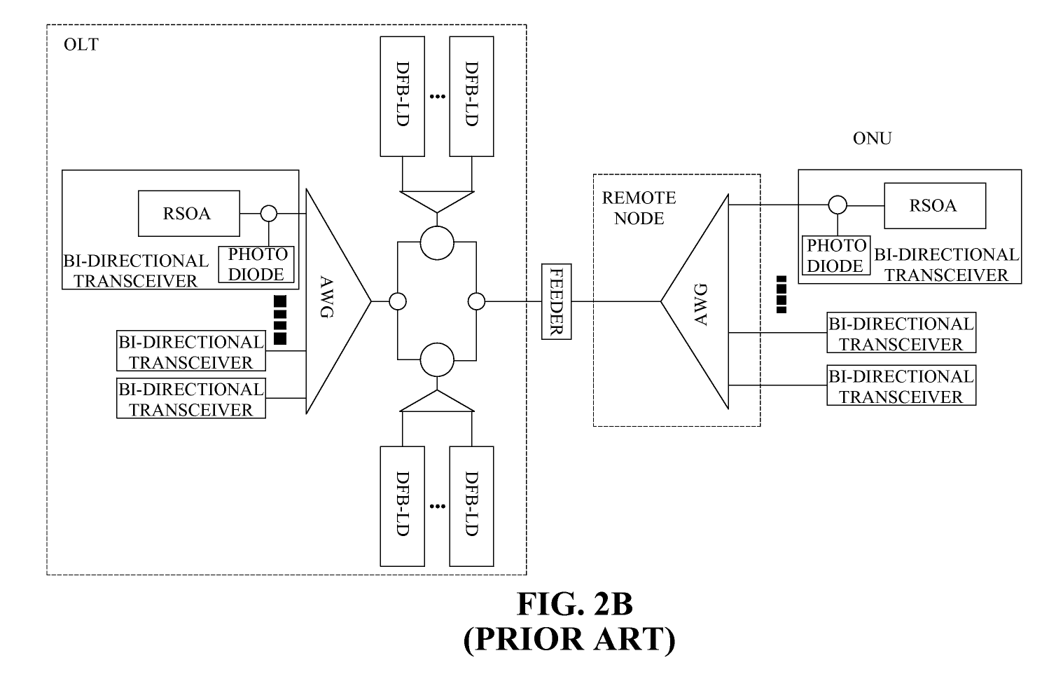

FIG. 3A shows a schematic view of an exemplary laser source based on FP-LD and used as a laser source of WDM laser architecture, consistent with certain disclosed embodiments of the present invention.

FIG. 3B shows an exemplary schematic view of each FP-LD in FIG. 3A being connected to a polarization controller, consistent with certain disclosed embodiments of the present invention.

FIG. 4 shows an exemplary schematic view of the output spectrums with and without seeding FP-LD, consistent with certain disclosed embodiments of the present invention.

FIG. 5 shows an exemplary schematic view of the output spectrums with and without seeding FP-LD in an operation environment, consistent with certain disclosed embodiments of the present invention.

FIG. 6 shows an exemplary flowchart of a laser source seeding method, consistent with certain disclosed embodiments of the present invention.

FIG. 7A shows an exemplary schematic view of the application of the embodiment in FIG. 3A to a WDM-PON transmission system based on RSOA, consistent with certain disclosed embodiments of the present invention.

FIG. 7B shows an exemplary schematic view of the application of the embodiment in FIG. 3B to a WDM-PON transmission system based on RSOA, consistent with certain disclosed embodiments of the present invention.

FIG. 8A shows an exemplary schematic view of the application of the embodiment in FIG. 3A as a downstream light source of a WDM-PON transmission system, consistent with certain disclosed embodiments of the present invention.

FIG. 8B shows an exemplary schematic view of the application of the embodiment in FIG. 3B as a downstream light source of a WDM-PON transmission system, consistent with certain disclosed embodiments of the present invention.

### DETAILED DESCRIPTION OF THE PREFERRED EMBODIMENTS

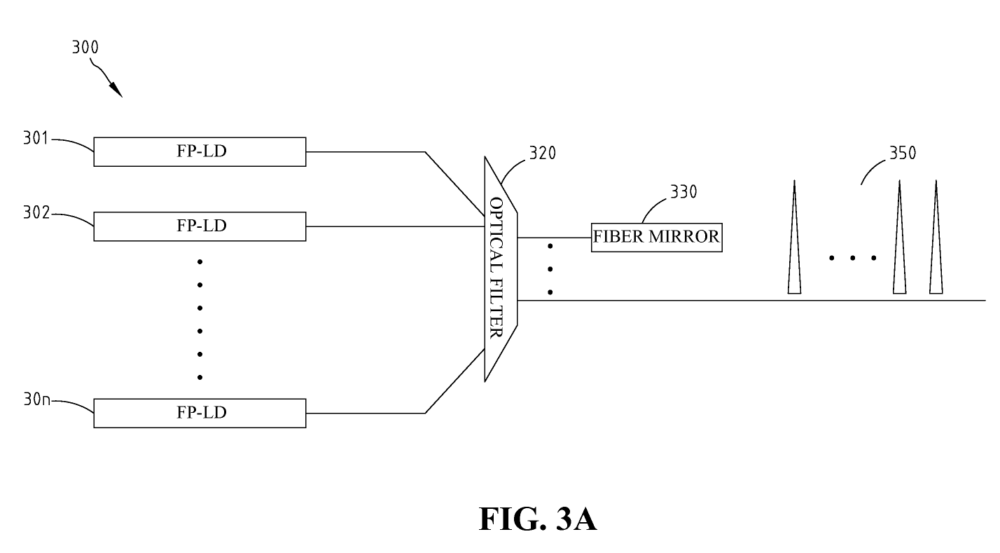

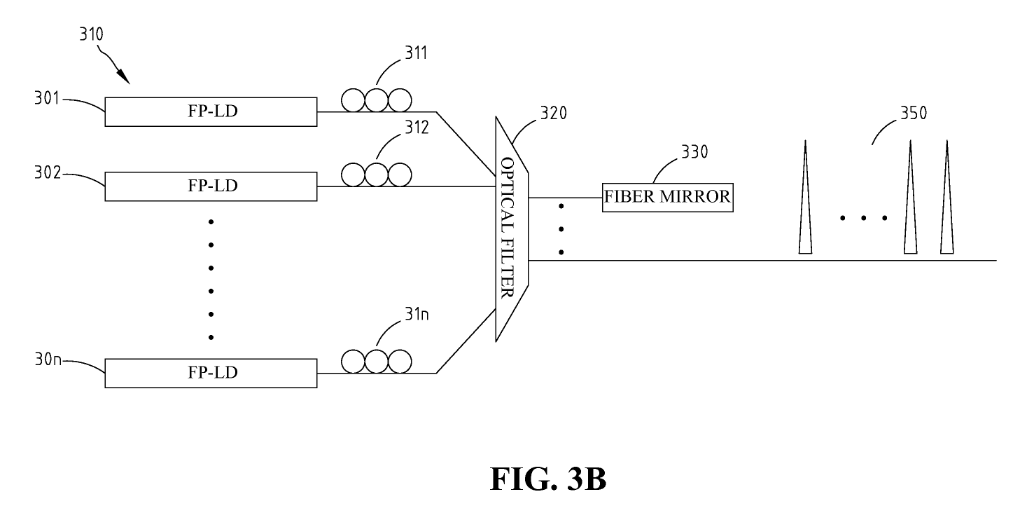

The exemplary embodiments according to the present invention may provide a laser source based on FP-LDs and the seeding method using the same. FIG. 3A shows a schematic view of an exemplary laser source based on FP-LD and used as a laser source of WDM laser architecture, consistent with certain disclosed embodiments of the present invention.

In the exemplary embodiment of FIG. 3A, laser source 300 comprises a plurality of FP-LDs 301-30n, an optical filter 320 and at least a fiber mirror (FM) 330. Each of FP-LDs 301-30n outputs a spectrum distributed within a range of a specific band. Optical filter 320 filters and identifies each spectrum from the FP-LDs 301-30n. Fiber mirror 330 reflects the identified spectrums into FP-LDs 301-30n. Then, each FP-LD outputs a continuous wave as a laser source 350 for seeding.

In the exemplary embodiment, FP-LD may adopt the output spectrum, such as multi-longitudinal mode (MLM), and the front-end surface of the FP-LD has a reflectivity around 45%. This FP-LD is an inexpensive FP-LD. In addition, the threshold current Iₜₕᵣₑₛ and the mode spacing Δλ are 9.5 mA and 1.38 nm, respectively. The MLM FP-LD, for example, may be distributed within the C-band. Fiber mirror 330 may reflect the wavelength, for example, which may be distributed within 1500 nm-1600 nm, with 99% reflectivity. Optical filter 320, for example, may use 1×4 array waveguide grating (AWG) as the filter.

In the exemplary embodiment of laser source 310 shown in FIG. 3B, each of FP-LDs 301-30n may be connected to a polarization controller (PC). Each of PCs 311-31n may control the polarization state of its connected FP-LD to maintain the stability of the output wavelength and obtain the maximum output power. Optical filter 320 identifies each spectrum through the spectrum filtering after passing through the PC. However, it is optional to connect each FP-LD to a PC.

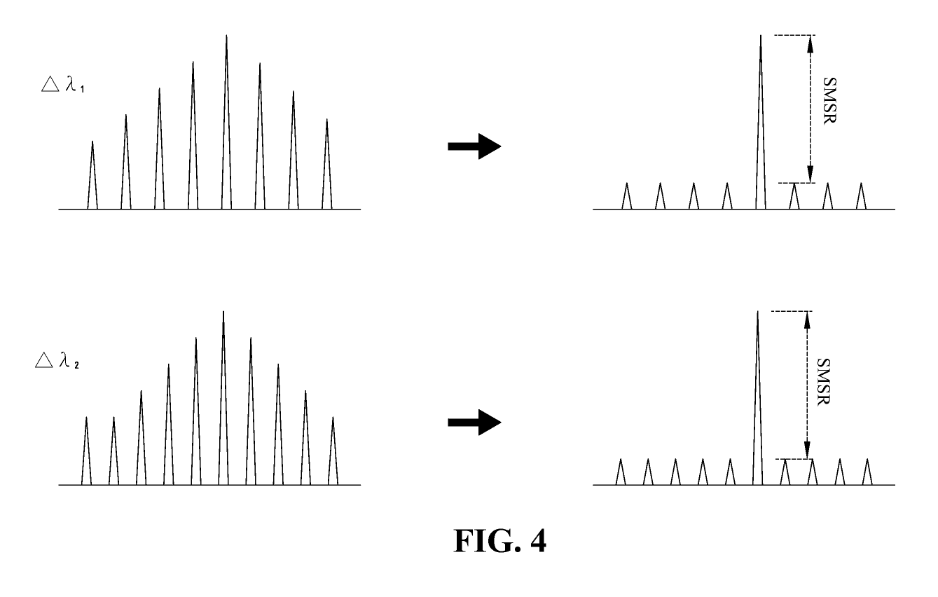

FIG. 4 shows an exemplary schematic view of the output spectrums with and without seeding FP-LD, consistent with certain disclosed embodiments of the present invention. The top and bottom figures on the left are the schematic view of the original output spectrum of FP-LD when threshold current is Δλ₁ and Δλ₂, respectively. The top and the bottom on the right show the schematic view of the output spectrum of FP-LD after seeding. The side-mode suppression ratio (SMSR) of the excited output wavelength is shown as the dash arrow in FIG. 4. From the SMDR of the top and bottom figures on the right, it may be seen that the disclosed CW WMD laser architecture according to the present invention may be applied to the FP-LD with different or same mode spacing (Δλ) in OLT to ensure the output of the multi-wavelength CW.

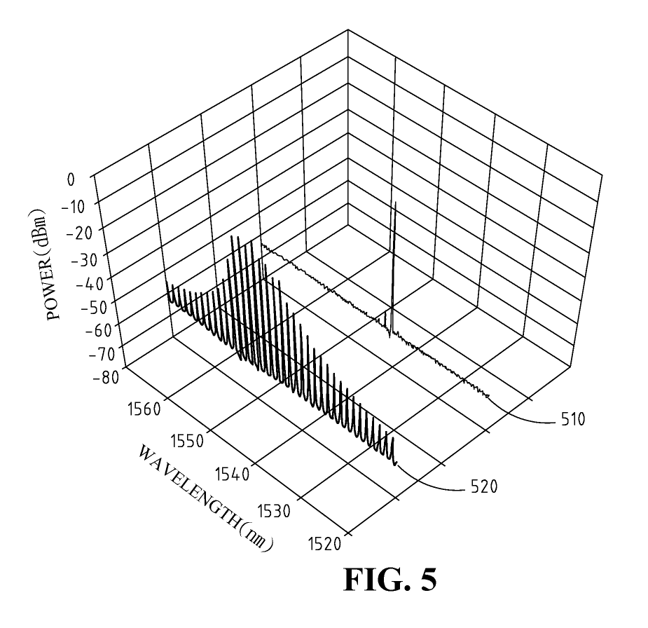

An exemplary experimental environment may include: MLM FP-LD with bias current 25 mA, and the AWG (3-dB bandwidth 0.45 nm) corresponding mode being 1540.4 nm. FIG. 5 shows an exemplary schematic view of output spectrum 520 of FP-LD without seeding and output spectrum 510 of FP-LD with seeding under the above experimental environment, consistent with certain disclosed embodiments of the present invention. As shown in output spectrum 510 of FP-LD with seeding, the excited output wavelength is 1540.5 nm after seeding, and the power and the SMSR of the excited output wavelength are −8 dBm and 52 dB, respectively.

If optical filter 320 is a tunable bandpass filter (TBF), optical filter 320 may be made as the only tunable laser source with above FP-LD. As seen in the experiment, the tunable wavelength range is between 1528-1562 nm, the minimum output power is −10 dBm, and the minimum SMSR is above 40 dB.

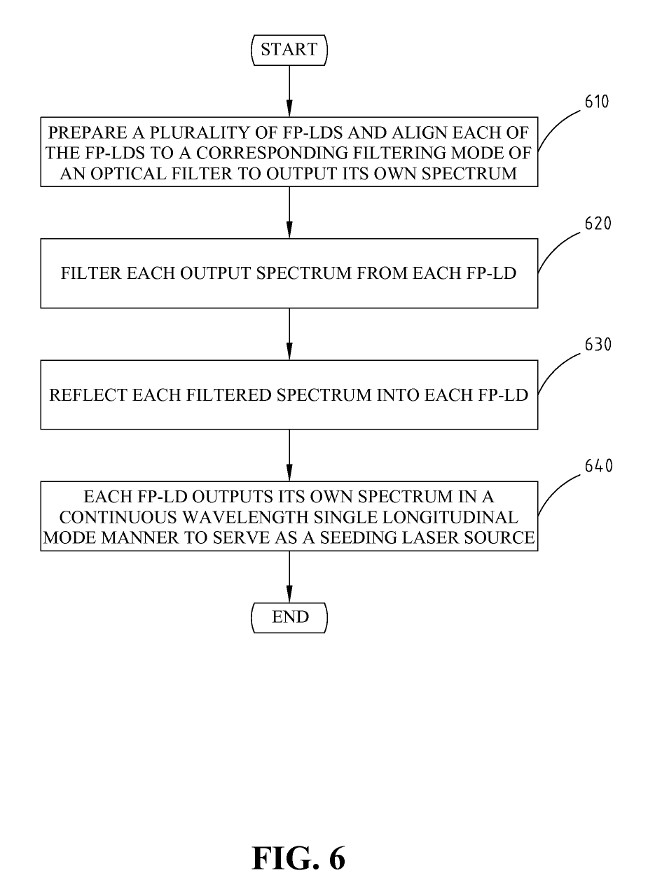

FIG. 6 shows an exemplary flowchart of a laser source seeding method, consistent with certain disclosed embodiments of the present invention. Referring to FIG. 6, in step 610, a plurality of FP-LDs are prepared and each of the FP-LDs is aligned to a corresponding filtering mode of an optical filter to output its own spectrum. Each spectrum from each of the FP-LDs is filtered by the optical filter, as shown in step 620. In step 630, the plurality filtered spectrums are reflected into the FP-LDs. In step 640, each FP-LD outputs its own spectrum in a continuous wavelength (CW) single longitudinal mode (SLM) manner to serve as a seeding laser source.

As aforementioned, in step 610, each FP-LD may be integrated with a connected polarization controller (PC) to control the polarization state of the connected FP-LD. In addition, FP-LDs, for being used in OLT, either with the same mode spacing or with the different mode spacing may be selected to ensure the outputs of the multi-wavelength CW. In step 630, the plural filtered spectrums are reflected by at least a fiber mirror. The low-cost FP-LD component with front-end reflectivity about 45% may also be used as the fiber mirror. In step 640, the CW SLM may be used as the laser source for directly seeding to a RSOA in an ONU. Depending on the application environment, the wavelength of the CW SLM may also be amplified before seeding to the RSOA in the ONU.

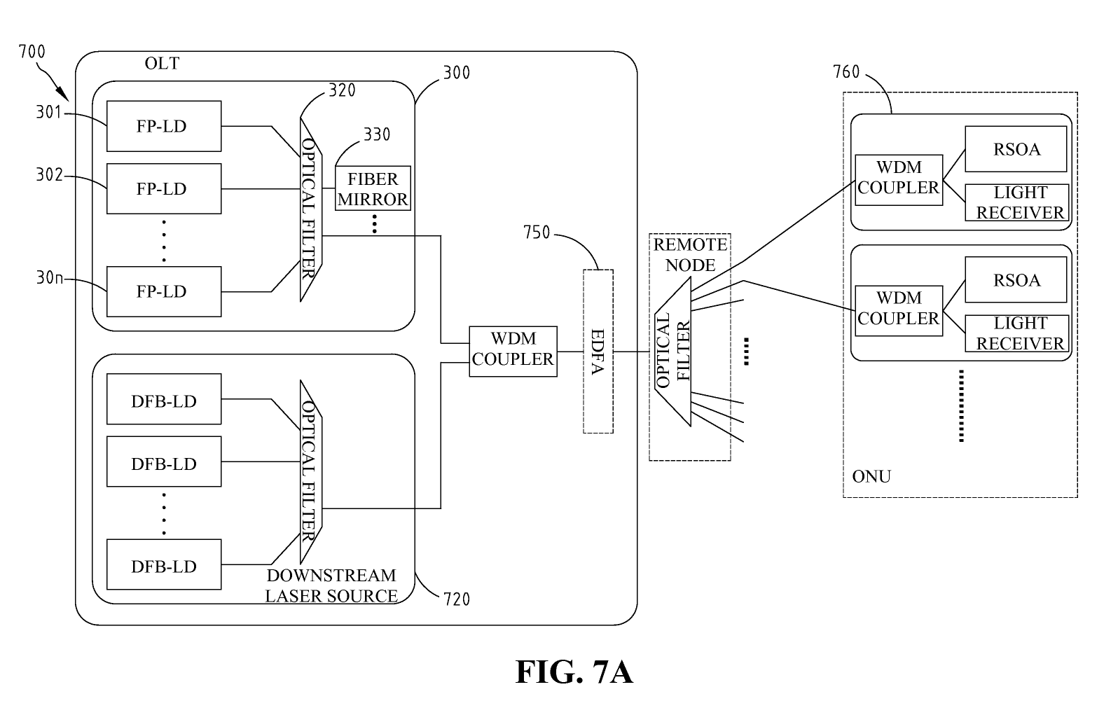

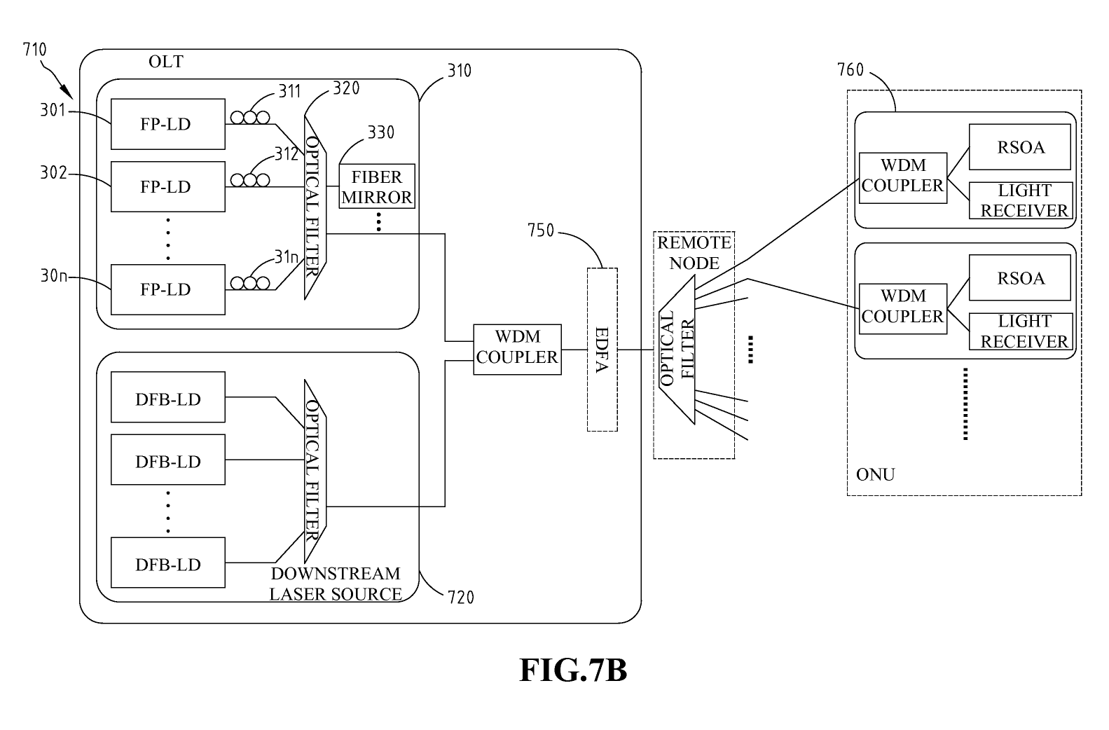

Laser source 300 or 310 may be applied to the colorless light source WDM-PON transmission architecture. FIGS. 7A and 7B show the exemplary schematic view of of the application of the embodiments in FIGS. 3A and 3B to a WDM-PON transmission architecture based on RSOA, consistent with certain disclosed embodiments of the present invention.

Refer to FIGS. 7A and 7B simultaneously. Transmission systems 700 and 710 may use laser sources of different band ranges, such as C-band (1530 nm-1560 nm) and L-band (1560 nm-1610 nm), as the upstream and downstream carrier light source, respectively, so as to avoid the upstream and downstream light signals using the same wavelength which may cause pulse noise because of Rayleigh Backscattering (RB) characteristic and lead to signal distortion. Each unit in an ONU with the colorless light source, marked as 760, may consist of a WDM coupler (WC), a RSOA and an optical receiver. The WDM coupler separates the upstream signals from the downstream signals.

In other words, the OLU in a transmission system may use laser sources 300 or 310 architecture of different band ranges as the upstream light signal and using DFB-LD architecture as downstream laser source 720, respectively, shown as the figure to the left of the remote node in FIGS. 7a and 7B.

With laser source 300 or 310 and the seeding operation, FP-LD may output the spectrum of CW SLM format. The outputted CW SLM spectrum may be used as the laser source for seeding directly to the RSOA in the ONU. Before entering the remote node (RN), the CW SLM wavelength may also be amplified by Erbium-doped fiber amplifier (EDFA) to increase the seeding power and compensate the loss of the passive components. In the WDM-PON transmission architecture of FIGS. 7A and 7B, the addition of EDFA 750 is optional.

In both colorless light source WDM-PON transmission systems 700 and 710, C-band seeding FP-LD and L-band DFB-LD may be used as the upstream and downstream light signals. In an exemplary experimental measurement, the upstream signal uses the laser source of the architecture disclosed in the present invention to seed a RSOA (with seeding wavelength 1540.5 nm) and performs 2.5 Gbit/s non-return-to-zero (NRZ) encoding modulation to the RSOA. In other words, the direct modulation is performed on the RSOA using the 2.5 Gbit/s of the 2⁷−1 word code byte with pseudo random binary sequence (PRBS). The direct current (DC) bias and the radio frequency (RF) voltage Vₚ₋ₚ of the RSOA are 4V and 5.2V, respectively. In this experimental measurement, the RN uses a 1×4 AWG to separate the upstream and downstream data transmission routes, and uses CW for seeding each unit of ONU.

To prove the feasibility of using the simple and low-cost CW multi-wavelength laser architecture of the present invention to realize the colorless light source WDM-PON based on RSOA, the bit error rate (BER) of the upstream communication of the WDM-PON and corresponding eye diagram are measured in the experiment measurements. From the measurements, when the BER of the upstream communication is 10⁻⁹, the received power penalty of the upstream communication is lower than 0.5 dB. As the minimum output light power is −10 dBm in the CW multi-wavelength laser architecture of the present invention, the 2.5 Gbit/s upstream data transmission rate may be realized and maintained on the PON architecture.

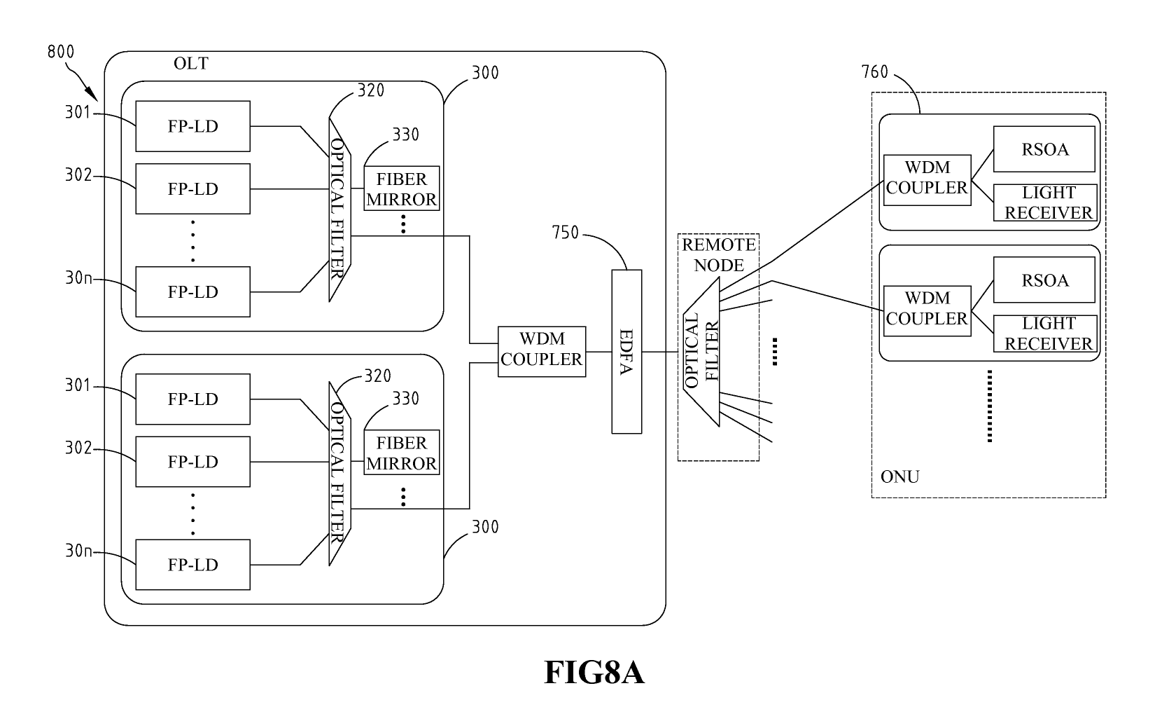

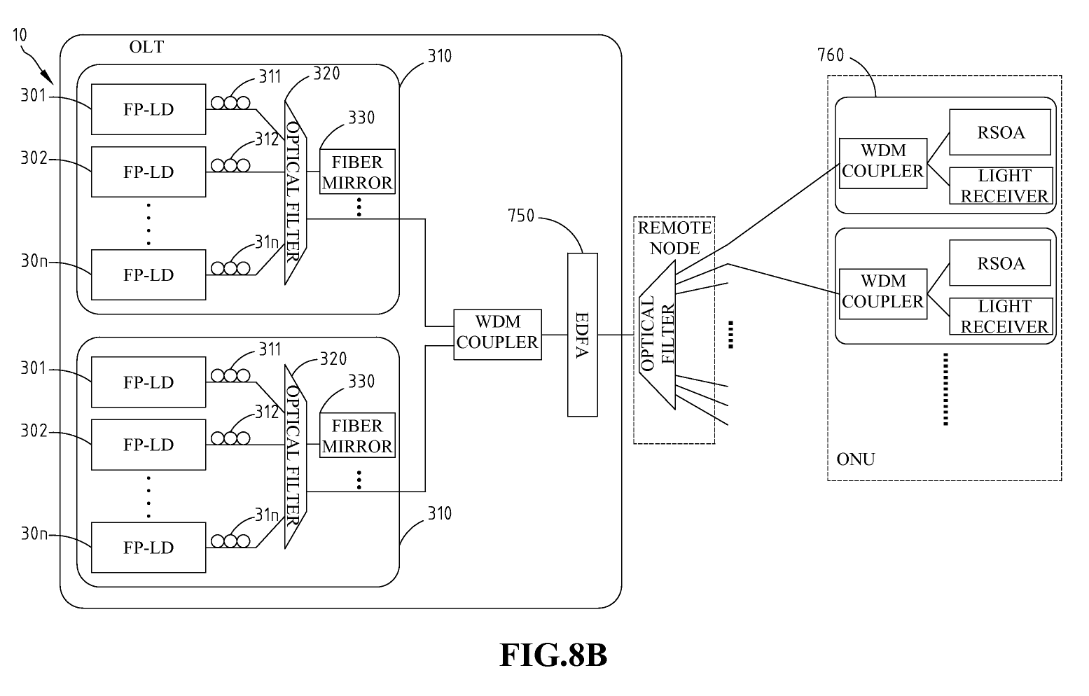

In addition to serve as the CW seeding light source to the ONU, the laser source of FIGS. 3A and 3B may also be used as the downstream light signal source. FIGS. 8A and 8B show exemplary schematic views of the application of the embodiment in FIGS. 3A and 3B as a downstream light source of a WDM-PON transmission system, consistent with certain disclosed embodiments of the present invention.

Referring to FIG. 8A, in WDM-PON transmission architecture 800, laser architecture 300 may be used as the downstream light signal source in addition to CW seeding light source of ONU. Similarly, in WDM-PON transmission architecture 810, laser architecture 310 may be used as the downstream light signal source in addition to CW seeding light source of ONU, as shown in FIG. 8B.

In transmission architecture 800 or 810, the upstream laser source to ONU and the downstream light signal may use different bands respectively, such as C-band and L-band. The upstream output laser source and the downstream output laser source may be separated by a WDM coupler. Similarly, the addition of EDFA in the WDM-PON architecture of FIGS. 8A and 8B is also optional.

In the WDM-PON architecture of FIGS. 8A and 8B, laser source 300 or 310 may be used as the downstream light signal source, and the transmission data may be directly modulated to 1 Gbps.

In summary, the seeding laser source based on FP-LD of the present invention may be applied to WDM-PON transmission system, such as the colorless light source WDM-PON transmission system and WDM-PON based on RSOA. The laser source is an inexpensive CW optical fiber laser source. In addition to serve as the seeding light source, the present invention may also be used as the downstream light signal. As shown in the exemplary experiment measurement, the upstream data transmission rate may reach 2.5 Gbits/s for a RSOA based transmission system. The laser source may modulate the wavelength within the range 1528-1562 nm. The minimum output power for the laser source is −10 dBm and the minimum SMSR for the laser source is above 40 dB.

Although the present invention has been described with reference to the exemplary disclosed embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A laser source based on Fabry-Perot laser diodes (FP-LDs), comprising:
a plurality of FP-LDs, each of said plurality of FP-LDs outputting own spectrum distributed within a specific frequency band;
an optical filter for filtering said output spectrum from each of said plurality of FP-LDs and identifying each outputted spectrum; and
at least a fiber mirror for reflecting each identified spectrum into each of said plurality of FP-LDs; each of said plurality of FP-LDs then outputting own continuous wavelength (CW) for serving as a laser light source of direct seeding.

2. The laser source as claimed in claim 1, wherein said optical filter is either a tunable bandpass filter or an array waveguide grating.

3. The laser source as claimed in claim 1, wherein said CW is in a single longitudinal mode.

4. The laser source as claimed in claim 1, said laser source is a seeding laser source.

5. The laser source as claimed in claim 1, said laser source is applied to a wavelength-division-multiplexed passive optical network (WDM-PON) transmission system.

6. The laser source as claimed in claim 1, wherein each of said plurality of FP-LDs has a front-end reflectivity close to 45%.

7. The laser source as claimed in claim 1, said laser source further includes a plurality of polarization controllers, with each of said plurality of polarization controllers controlling the polarization stats of a corresponding FP-LD connected to said polarization controller.

8. The laser source as claimed in claim 5, wherein said WDM-PON transmission system uses said laser source as a seeding light source.

9. The laser source as claimed in claim 5, wherein said WDM-PON transmission system uses said laser source as a downstream light signal source.

10. The laser source as claimed in claim 5, wherein said WDM-PON transmission system uses said laser source as an upstream laser source and a downstream laser source, and said upstream laser source and said downstream laser source use different band ranges respectively.

11. The laser source as claimed in claim 7, wherein each of said plurality of polarization controllers is integrated to a corresponding FP-LD connected to said polarization controller.

12. The laser source as claimed in claim 5, wherein said WDM-PON transmission system is a colorless light source WDM-PON transmission system.

13. The laser source as claimed in claim 5, wherein said WDM-PON transmission system is a WDM-PON transmission system based on the reflective semiconductor optical amplifier.

14. A laser source based on Fabry-Perot laser diodes (FP-LDs), applicable to an optical line terminal (OLT) in a transmission system, said OLT having an upstream laser source and a downstream laser source, said laser source comprising:
a plurality of FP-LDs, each of said plurality of FP-LDs outputting own spectrum distributed within a specific frequency band;
an optical filter for filtering said output spectrum from each of said plurality of FP-LDs and identifying each outputted spectrum; and
at least a fiber mirror for reflecting each identified spectrum into each of said plurality of FP-LDs; each of said plurality of FP-LDs then outputting own continuous wavelength (CW) in a single longitudinal mode, said OLT using said laser source as an upstream laser source and a downstream laser source, and said upstream laser source and said downstream laser source using different band ranges respectively.

15. The laser source as claimed in claim 14, said laser source is applied to a wavelength-division-multiplexed passive optical networks (WDM-PON) transmission system.

16. The laser source as claimed in claim 14, wherein each of said plurality of FP-LDs has a front-end reflectivity close to 45%.

17. The laser source as claimed in claim 14, wherein each of said plurality of FP-LDs is connected to a corresponding polarization controller for controlling the polarization state of said FP-LD.

18. The laser source as claimed in claim 15, wherein said OLT uses a WDM coupler to separate said upstream laser source from said downstream laser source.

19. A seeding method of using a laser source based on Fabry-Perot laser diodes (FP-LDs), said method comprising:
preparing a plurality of FP-LDs and aligning each of said plurality of FP-LDs to a corresponding filtering mode of an optical filter, each of said plurality of FP-LDs outputting own spectrum;
filtering said outputted spectrum from each of said plurality of FP-LDs;
reflecting said filtered spectrum into each of said plurality of FP-LDs; and
each of said plurality of FP-LDs outputting a continuous wavelength (CW) in a single longitudinal mode, and said CW being used as a laser light source for seeding.

20. The seeding method as claimed in claim 19, said method further including:
integrating each of said plurality of FP-LDs with a connected polarization controller for controlling the polarization state of said FP-LD.

21. The seeding method as claimed in claim 19, said method further including:
selecting FP-LDs of the same or different mode spacing for being used in an optical line terminal to ensure outputting multi-wavelength CW.

22. The seeding method as claimed in claim 19, further including:
determining whether to amplify said output spectrum of CW SLM before using as said laser light source for seeding.
